(19) United States
(12) Patent Application Publication
(10) Pub. No.: US 2014/0122371 A1
(43) Pub. Date: May 1, 2014

(54) System and Method for outcome-oriented Investing

(71) Applicant: Karan Sood, Wahington, DC (US)

(72) Inventor: Karan Sood, Wahington, DC (US)

(21) Appl. No.: 13/694,122

(22) Filed: Oct. 31, 2012

(51) Int. Cl. G06Q 40/06; G06Q 40/04

(52) U.S. Cl. CPC G06Q 40/06; G06Q 40/04
USPC 705/36 R

(57) ABSTRACT

A method for outcome-oriented investing is provided. A unit investment trust is established. An intended non-linear economic outcome structured to reference underlying assets is established. Securities and the weights of those securities are selected in compliance with unit investment trust requirements such that the unit investment trust delivers the intended non-linear economic outcome. For example, the securities selected are liquid, and active management of the securities held in the unit investment trust is not allowed. In one example embodiment described herein, at least one U.S. Treasury bond and at least one exchange-traded option are selected.

### FIELD OF THE INVENTION

The present invention relates to a system and method of investment and to the electronic trading, delivering, clearing, and settling of such financial instruments.

### BACKGROUND OF THE INVENTION

Many different types of financial instruments are traded throughout the world. Examples include equities, bonds, cash contracts, and derivatives. The attributes of equities and bonds are generally well known. A cash contract is an agreement to deliver the specified asset. A derivative is a financial instrument whose value is linked to the price of an underlying commodity, asset, rate, index, currency or the occurrence or magnitude of an event. Typical examples of derivatives include futures, forwards, options, and swaps.

Investing has evolved over the last century—the arrival and explosive growth of mutual funds, the proliferation of asset allocation strategies, the quest for alpha and, most recently, the advent of custom and outcome-oriented solutions or outcome-driven investing—all impact investment decision making.

Outcome-oriented solutions refers to financial products or investing strategies that involve investors purchasing a set of securities or financial instruments that result in a well-defined economic outcome at a specific time in the future. This has been made possible in recent times due to advances in financial and computational technology. More specifically, outcome-driven investing includes explicitly measured potential risk and return, optimized risk-return, and holding period discipline.

With respect to explicitly measured potential risk and return, market participants typically use very uncertain measures of risk and returns. Most often risk is expressed using backward looking measures such as volatility. Outcome-based investing uses explicit measures of risk and returns, most often expressed as maximum allowable potential loss and maximum potential gain.

With respect to optimize risk/return, by providing explicit measures of potential risk and return, outcome-based investing allows investors to choose specific outcomes that optimize expected returns between downside protection and upside returns. Each investor is then empowered to choose an investment strategy that specifically meets their personal level of comfort on the risk/return spectrum. The risk/return spectrum is defined explicitly in terms of potential loss and potential gain at a specific point in time in the future.

With respect to holding period discipline, by targeting specific risk and returns at a specific point in time in the future, outcome-based investing encourages a holding discipline in investing. While providing liquidity for the investor to exit their investment strategies, outcome-based investing discourages a trading mentality.

Returns of most financial products are linear in nature—that is, the profit and loss are equally distributed. For example, an investor profits linearly from a stock position if the stock price increases and suffers a loss when stock price depreciates. In the last three decades, financial technology has progressed to provide access to non-linear outcomes. For example, an investor can profit from a rising stock price but can limit losses from a declining stock price. Such non-linear outcomes allow investors to design investments that target specific economic outcomes.

A non-linear economic outcome to be delivered to the investor links the economic outcome to a reference asset that could be a security, an index of securities, a commodity or an index of commodities. A non-linear economic outcome to be delivered to the investor delivers the economic outcome only at a certain specific date in the future. A non-linear economic outcome to be delivered to the investor can customize the economic outcome on multiple dimensions.

The economic outcome can be customized to provide a certain level of protection on the downside which, depending upon the product, can vary from 0% (that is, the investor has full participation to the negative returns of the reference assets and could lose all their investment) to 100% (that is, the investor does not participate in any negative returns of the reference asset, and the investor initial investment is fully protected conditional on the creditworthiness of the U.S. Government and clearing counterparty).

The economic outcome can be customized to provide a certain level of variable participation on the upside up to a maximum return which, depending upon the product, can vary from 0% (that is, the investor does not participate in any positive returns of the reference asset) to 100% (that is, the investor's initial investment is fully protected conditional on the creditworthiness of the U.S. Government and clearing counterparty).

The economic outcome can be customized to limit the economic outcome to a maximum return that could vary between, for example, 2% (that is, the investor cannot expect a return more than 2%) to infinity (that is, the investor's return is proportional to the return of the reference asset as is unbounded). And the economic outcome can be customized to provide a customized level of income in form of periodic fixed coupons independent of or conditional on the performance of the reference asset.

Several outcome-based investing products exist in the market, including structured notes, unit investment trusts, exchange listed options, and FLexible EXchange® Options (FLEX Options).

Structured notes are debt obligations of an issuer that include a contingent economic outcome tied to the performance of a specified benchmark or index. By their nature, structured notes provide a means for delivering non-linear outcomes. Structured notes have a fixed term, may be offered publicly or private, and may or may not be exchange listed.

While structured notes are a vehicle to deliver non-linear outcomes, structured notes suffer from drawbacks. Structured notes concentrate credit risk. Structured notes are unsecured debt obligations of the issuing entity, typically a financial institution. In case of a default by the issuing entity, investors can lose a significant amount if not all their investment. Due to this, structured notes involve a concentrated credit exposure to the issuer.

Structured notes also suffer from a lack of a committed secondary market. Structured notes, like debt instruments, are issued at par and are redeemed at maturity. Most issuers do not have a legal or contractual obligation to make a secondary market. Once bought, the only channel available for investors to exit their investments in notes is to sell the note to the issuer, on the best efforts of the issuer and often at a discount to economic value.

And structured notes suffer from a lack of transparency. Structured notes are not investment companies. As such, they are not subject to the Investment Company Act of 1940, codified at 15 U.S.C. §§80a-1-80a-64. (“1940 Act”) registration or the limitations imposed on the 1940 Act-registrants.

Unit investment trusts (“UITs”) are an investment company regulated under the Investment Company Act of 1940. UITs are fixed-term vehicles that hold substantially fixed portfolios that are not subject to active management. Investors in UITs may redeem their interests on a daily basis at a price based on current net asset value (NAV). A trust indenture governs the administration of the UIT, as well as the activities of the sponsor of the UIT, a trustee, and an evaluator. Typically, the sponsor/depositor accumulates securities, and deposits them into the trust governed by the trustee. In return, the sponsor receives certificates from the trustee representing units of the trust that the sponsor offers to the public.

Exchange listed options are option securities traded on a regulated exchange, where the terms of each option are standardized by the exchange. The option security is standardized so that reference asset, quantity, expiration date, and strike price are known in advance. Listed options cover reference assets such as common stocks, exchange traded funds (“ETFs”), market indexes and commodities, and trade on exchanges such as Chicago Board Options Exchange, 400 South LaSalle Street Chicago Ill. 60605(“CBOE”) or Euronext N.V., Beursplein 5 Amsterdam Netherlands 1012JW. Listed options are centrally cleared by the Options Clearing Corporation , One North Wacker Drive, Suite 500, Chicago, Ill. 60606 (“OCC”) in the United States. Price discovery is ensured by the exchanges through competitive and transparent auction mechanisms, complemented by independent daily valuation by OCC.

FLexible EXchange® Options (“FLEX Options”), made available by the CBOE, are customized equity or index exchange listed option contracts made available by a regulated exchange. FLEX Options provide investors with the ability to customize key contract terms, like exercise prices, exercise styles and expiration dates.

In summary, it would be desirable to offer an outcome-oriented solution that does not concentrate credit risk. It would be desirable to offer an outcome-oriented solution that does not suffer from a lack of a committed secondary market. It would be desirable to offer an outcome-oriented solution that does not suffer from a lack of transparency.

### SUMMARY OF THE INVENTION

The present invention offers an outcome-oriented solution that does not concentrate credit risk. The present invention offers an outcome-oriented solution that does not suffer from a lack of a committed secondary market. The present invention offers an outcome-oriented solution that does not suffer from a lack of transparency. In accordance with the principals of the present invention, a method for outcome-oriented investing is provided. A unit investment trust is established. An intended non-linear economic outcome structured to reference underlying assets is established. Securities and the weights of those securities are selected in compliance with unit investment trust requirements such that the unit investment trust delivers the intended non-linear economic outcome. For example, the securities selected are liquid, and active management of the securities held in the unit investment trust is not allowed. In one example embodiment described herein, at least one U.S. Treasury bond and at least one exchange-traded option are selected.

### BRIEF DESCRIPTION OF THE DRAWINGS

FIG. 1 is a flow-chart setting forth an example of a system and method for outcome-oriented investing in accordance with the principles of the present invention.

FIG. 2 is a graph showing the performance of a non-limiting example of an embodiment of the present invention in which a fully principal protected outcome is replicated.

FIG. 3 is a graph showing the performance of another non-limiting example of an embodiment of the present invention in which a partially principal protected outcome with enhanced upside is replicated.

FIG. 4 is a graph showing the performance of another non-limiting example of an embodiment of the present invention in which a partially principal protected outcome with a fixed coupon is replicated

FIG. 5 is a non-limiting example of a hardware infrastructure that can be used to run a system that implements electronic clearing and settling of the financial instrument of the present invention.

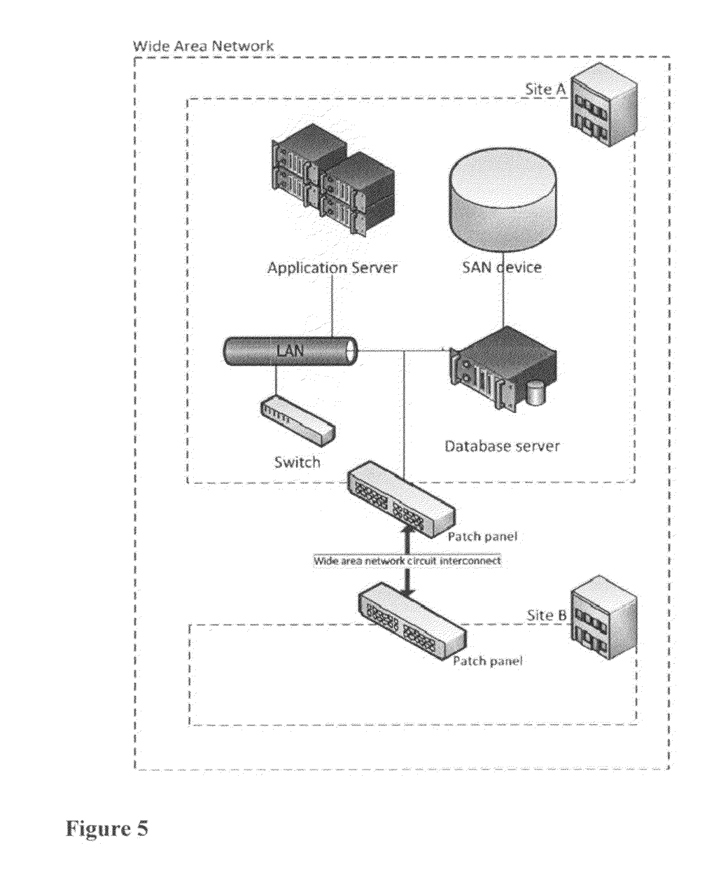

### DETAILED DESCRIPTION OF PREFERRED EMBODIMENTS

In accordance with the principles of the present invention, a system and method of investment and, more particularly, an investment vehicle is provided. The investment vehicle buys and holds a unique set of securities in a unit investment trust (“UIT”) structure with a fixed term with the objective of delivering a unique non-linear economic outcome.

The present invention is a means to deliver non-linear economic outcomes by having a UIT hold a unique selection of securities. This involves using a process to determine the selection of securities that deliver the intended non-linear economic outcome and are in compliance with UIT requirements, as detailed by the Investment Company Act of 1940, codified at 15 U.S.C. §§80a-1-80a-64 (“1940 Act”). The investment vehicle overcomes the drawbacks of alternative delivery vehicles for such non-linear outcomes.

In the following description the invention is described with reference to certain examples. It is to be understood that structural, procedural, and systemic changes may be made without departing from the spirit and scope of the present invention. The description, therefore, is not to be taken in a limiting sense, and the scope of the present invention is defined by the appended claims and their equivalents.

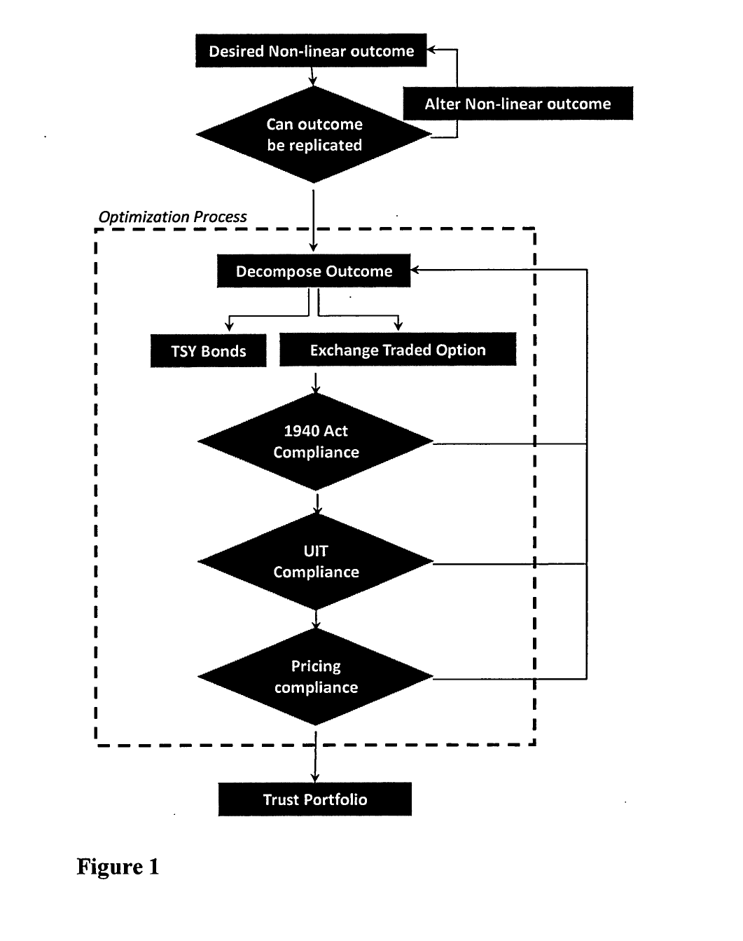

In more detail, referring to FIG. 1 a flow-chart setting forth an example of a system and method for outcome-oriented investing in accordance with the principles of the present invention is seen. Embodiments of the present invention facilitate the creation, operation, and management of a UIT in the form of a series trust having units available for purchase by an investor while, at the end of a fixed term, providing a non-linear economic outcome. These embodiments enable investment in any number of assets of various types, ranging from relatively straight forward to relatively complex portfolios.

As aspect of the invention is the realization under the 1940 Act—unlike structured notes, open-ended mutual funds or closed-end funds—UITs have restrictions on what securities can be purchased and how these securities are managed. These restrictions make it difficult to deliver the non-linear outcomes that other delivery vehicles—such as structured notes, open-ended mutual funds or closed-end funds—may be able to deliver.

Such restriction include holding only liquid securities as defined by the 1940 Act, holding these securities in certain proportions to meet certain diversification requirement imposed by the 1940 Act and Internal Revenue tax guidelines, and holding these securities static over the life of the trust without allowing for any active management (that is, selling, purchasing or replacing the securities as dictated by the 1940 Act). The present invention has embodiments that allow a UIT to be operated within the constraints of these restrictions, but still deliver the intended non-linear outcome.

A further aspect of the invention is the realization that structured notes—which are the most popular delivery vehicle for non-linear economic outcomes—suffer from certain drawbacks that the present invention—which involves a UIT holding a unique set of securities—overcomes. The present invention achieves the objective of delivering non-linear economic outcomes in a UIT, meeting the requirements of the 1940 Act, and overcoming the drawbacks of structured notes.

The UIT of the present invention invests in the following combination of securities: U.S. Treasury securities and standard exchange-traded option contracts of various strikes; U.S. Treasury securities and long term exchange traded option contracts called LEAPS of various strikes; U.S. Treasury securities and customizable exchange traded option contracts called FLEX Options of various strikes; exchange listed registered investment companies and customizable exchange traded option contracts called FLEX Options of various strikes; customizable exchange traded option contracts called FLEX Options of various strikes; and various combinations thereof.

The appropriate securities and the weights of those securities in the trust are selected such that the UIT delivers the intended non-linear economic outcome, meets the requirements of the 1940 Act, and overcomes the drawbacks of structured notes. The appropriate securities and the weights of those securities in the trust are selected by a computational optimization process. A desired non-linear outcome can be replicated by using a various trading strategies. Each of these numerous trading strategies can involve numerous combination of static securities or a dynamic selection of securities that can be bought and sold at various times during the life of the strategy to deliver the non-linear outcome. A computational iterative process, referred to an the optimization process, is used to determine an appropriate strategy that will deliver the non-linear outcome.

This computations process involves can include iterative loop, under which a computer will test the strategy for compliance with limitations imposed by the Investment Company Act of 1940 and limitations imposed by the UIT structure. If there are numerous strategies that are in compliance with the above two constraints, the computer can be programmed to choose the strategy that achieves an auxiliary condition. Such condition could be a minimizing the cost of implementing the strategy or a desired tax treatment for the returns from the strategy. In particular embodiments, the trust termination date is configured to correspond to a holding period of the trust's portfolio and options of similar maturity date, which can vary for example from one month to ten years.

The exchange traded options of various kinds that trade on the exchanges are structured to reference underlying assets, without the trust necessarily holding these underlying assets. Rather, the trust may be invested primarily in other assets, which may include U.S. Treasuries (or other cash-like securities). This enables the trust, for example, to benefit from the safety of cash, and avoid risks associated with underlying assets, such as indices, exchange traded funds (“ETFs”), etc., while also enabling the investor to participate in growth of those underlying assets through the options.

This may also help minimize counterparty risk in comparison to structured notes, as the primary holding of the trust include U.S. Treasuries (or other cash-like securities) and options that are cleared by a highly rated credit central clearing entity. In addition, by being governed under the 1940 Act, embodiments of the invention will help mitigate the other drawbacks suffered by structured notes, such as the lack of secondary market (the 1940 Act requires units of the trust be redeemed at net asset value (“NAV”) by the trustee on demand) and lack of transparency (the 1940 Act requires extensive disclosure of fees and holdings and periodic third party audit).

The following are non-limiting examples of embodiments of the present invention.

### EXAMPLE 1

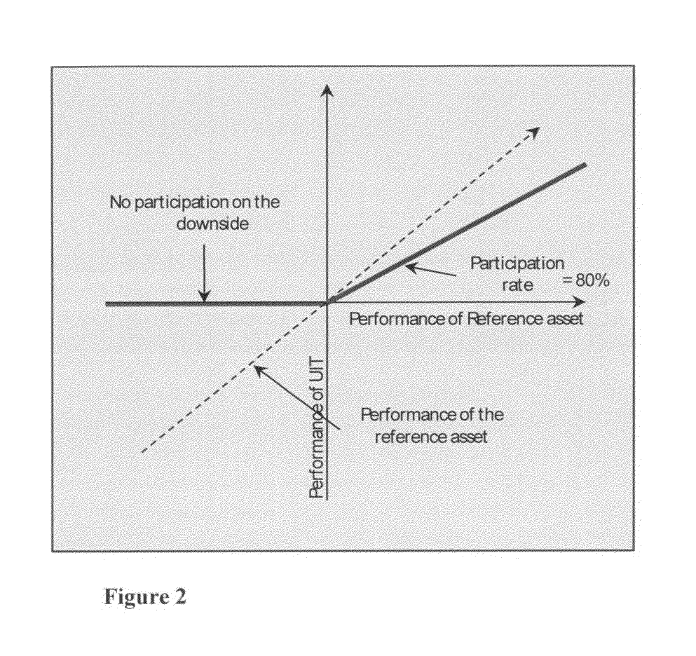

Referring to FIG. 2, a graph showing the performance of a non-limiting example of an embodiment of the present invention is seen. In this example, a principal protected outcome is to be replicated. At maturity the principal is protected (contingent on the creditworthiness of the US Government Treasury). A fixed participation in the return of the benchmark index (for example, 80% of the upside of S&P500 Index) is provided. The outcome can be delivered through a strategy that involves a UIT holding zero coupon U.S. Treasury bonds that price at a discount (for example, a five-year bond prices at 80%) and an exchange traded call option—as much can be bought from the discount of the zero coupon bond (for example, 20% can buy a 80% participation in a five-year call option on the S&P500 Index).

Typical features of the principal protected strategy include a reference asset—typically a broad benchmark such as the S&P500 Index; a maturity of typically five years or longer; price as a function of the prevailing interest rates; index volatility; and index dividends: higher interest rates lead to higher participation, lower volatility implies higher participation, and high dividends implies higher participation. As seen in FIG. 2, the strategy results in no participation on the downside and a participation rate of 80% as compared to the performance of the reference asset.

### EXAMPLE 2

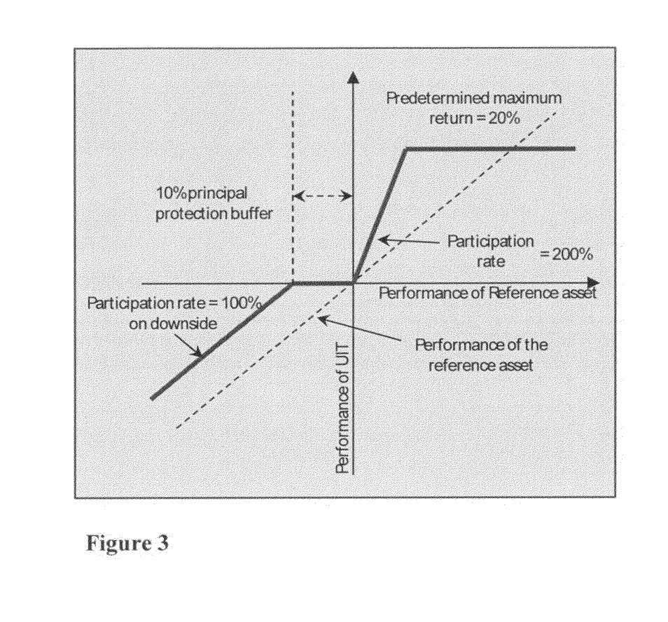

Referring to FIG. 3, a graph showing the performance of another non-limiting example of an embodiment of the present invention is seen. In this example, an outcome with enhanced participation on the upside and partial protection on the downside is to be replicated. The outcome results in partial protection on the downside by protecting the investor against a drop of the first x% (typically 10%) of the index, and thereafter participates one-to-one on the downside. Enhanced upside means that the outcome at maturity will be a return that is a multiple (for example, typically 2×) of the positive returns of the index. However, the return is capped at certain maximum return level (for example, typically 20%). The outcome can be delivered through a strategy that involves a UIT to hold zero coupon U.S. Treasury bond that prices at a discount (for example, a one year bond price at 95%) and exchange traded options. For example, the UIT sells a 90% strike put on the reference index for 1.11× the notional of the strategy and uses the proceeds from the sale of the put and bond discount to buy a (100/1xx) call spread for two times the notional of the strategy's investment.

The outcome can be structured in a different manner to ensure an alternative tax treatment. Typical features of the strategy include a reference asset—typically a broad benchmark such as S&P 500 Index; a maturity of typically one to two years;. As seen in FIG. 3, the strategy results in a predetermined maximum return of 20%, a 10% principal protection buffer, a participation rate of 200%, and a participation rate of 111% on the downside as compared to the performance of the reference asset.

### EXAMPLE 3

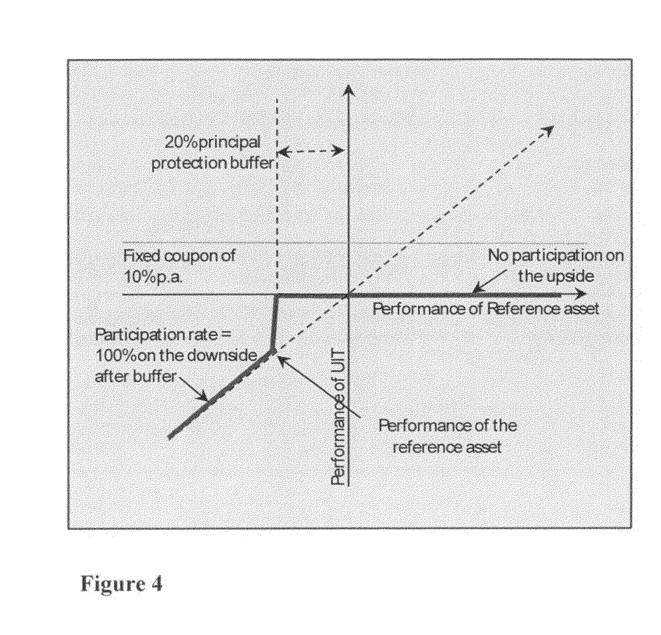

Referring to FIG. 4, a graph showing the performance of another non-limiting example of an embodiment of the present invention is seen. In this example, an outcome with no participation on the upside, partial protection on the downside and a fixed coupon is to be replicated. The outcome results in partial protection on the downside by protecting the investor against a drop of the first x% (typically 20%) of the index, and thereafter participates on the downside, as if the investor owned the index. The outcome targets no upside participation but a fixed coupon. The outcome can be delivered through a strategy that involves a UIT to hold zero coupon U.S. Treasury bond that prices at a discount (for example, a one year bond price at 95%) and exchange traded options. For example the UIT sell a leveraged 80%-Strike Put and buys a leveraged 78% Strike Put.

Again, the preceding are non-limiting examples of embodiments of the present invention. For the sake of brevity, examples have been given which are not exhaustive of the present invention. By way of further examples, an emerging markets assets fund could be created by referencing any asset that has listed option trading on a national exchange. These will include popular indices, most liquid single stocks and most liquid Exchange Traded Funds/Vehicles, for example, the iShares MSCI Emerging Markets Index Fund (EEM), a gold SPDR Gold Shares (GLD); and iShares Dow Jones U.S. Real Estate Index Fund (IYR).

Referring to FIG. 4 a non-limiting example of a high-level hardware implementation can used to run a system of the present invention is seen. The infrastructure should include but not be limited to: wide area network connectivity, local area network connectivity, appropriate network switches and routers, electrical power (backup power), storage area network hardware, server-class computing hardware, and an operating system such as for example Redhat Linux Enterprise AS Operating System available from Red Hat, Inc, 1801 Varsity Drive, Raleigh, N.C.

The clearing and settling and administrative applications software server can run for example on an HP ProLiant DL 360 G6 server with multiple Intel Xeon 5600 series processors with a processor base frequency of 3.33 GHz, up to 192 GB of RAM, 2 PCIE expansion slots, 1 GB or 10 GB network controllers, hot plug SFF SATA drives, and redundant power supplies, available from Hewlett-Packard, Inc, located at 3000 Hanover Street, Palo Alto, Calif. The database server can be run for example on a HP ProLiant DL 380 G6 server with multiple Intel Xeon 5600 series processors with a processor base frequency of 3.33 GHZ, up to 192 GB of RAM, 6 PCIE expansion slots, 16 SFF SATA drive bays, an integrated P410i integrated storage controller, and redundant power supply, available from Hewlett-Packard.

While the invention has been described with specific embodiments, other alternatives, modifications, and variations will be apparent to those skilled in the art. Accordingly, it will be intended to include all such alternatives, modifications, and variations set forth within the spirit and scope of the appended claims.

1. A method for outcome-oriented investing comprising:
establishing a unit investment trust;
entering into memory an intended non-linear economic outcome structured to reference underlying assets; and
with a processor in communication with the memory, selecting securities and selecting weights of those securities in compliance with unit investment trust requirements such that the unit investment trust delivers the intended non-linear economic outcome contingent on the performance of the reference underlying asset.

2. The method for outcome-oriented investing of claim 1 further comprising selecting liquid securities and not allowing active management of the securities held in the unit investment trust.

3. The method for outcome-oriented investing of claim 2 further comprising selecting liquid securities from the group consisting of U.S Treasury securities and standard exchange-traded option contracts of various strikes; U.S. Treasury securities and long term exchange traded option contracts of various strikes; U.S. Treasury securities and customizable exchange traded option contracts of various strikes; exchange listed registered investment companies and customizable exchange traded option contracts of various strikes; customizable exchange traded option contracts of various strikes; and
combinations thereof.

4. The method for outcome-oriented investing of claim 1 further comprising selecting at least one U.S. Treasury bond and at least one exchange-traded option.

5. The method for outcome-oriented investing of claim 4 further comprising selecting at least one zero coupon U.S. Treasury bond and at least one exchange traded option.

6. The method for outcome-oriented investing of claim 4 further comprising selecting at least one U.S. treasuries strip and at least one exchange-traded option.

7. The method for outcome-oriented investing of claim 4 further comprising selecting at least one U.S. treasuries strip and at least one exchange-traded call option.

8. The method for outcome-oriented investing of claim 4 further comprising selecting at least one U.S. treasuries strip and at least one exchange-traded put option.

9. The method for outcome-oriented investing of claim 1 further comprising, with an optimization process, selecting appropriate securities and the weights of those securities in compliance with unit investment trust requirements such that the unit investment trust delivers the intended non-linear economic outcome.

10. The method for outcome-oriented investing of claim 9 further comprising an iterative loop, with a processor testing a strategy for compliance with limitations imposed by the Investment Company Act of 1940 and limitations imposed by the unit investment trust structure.

11. The method for outcome-oriented investing of claim 10 further comprising selecting a strategy in compliance in compliance with limitations imposed by the Investment Company Act of 1940 and limitations imposed by the unit investment trust structure selected from a group consisting of minimizing the cost of implementing the strategy and establishing a desired tax treatment for the returns from the strategy.

12. The method for outcome-oriented investing of claim 1 further comprising linking to broad index that provides leveraged returns up to a cap on the upside and buffered protection on the downside.

13. The method for outcome-oriented investing of claim 1 further comprising entering an intended non-linear economic outcome structured to deliver an outcome with enhanced participation on the upside and partial protection on the downside.

14. The method for outcome-oriented investing of claim 1 further comprising entering an intended non-linear economic outcome structured to deliver a principal protected outcome.

15. The method for outcome-oriented investing of claim 1 further comprising entering an intended non-linear economic outcome structured to reference an equity.

16. The method for outcome-oriented investing of claim 1 further comprising entering an intended non-linear economic outcome structured to reference an exchange-traded fund.

17. The method for outcome-oriented investing of claim 1 further comprising entering an intended non-linear economic outcome structured to reference an index.
